(19) United States
(12) Patent Application Publication
(10) Pub. No.: US 2019/0094904 A1
(43) Pub. Date: Mar. 28, 2019

(54) CALCULATION DEVICE, IMAGE-PROCESSING DEVICE, AND IMAGE-PROCESSING METHOD

(71) Applicant: OLYMPUS CORPORATION, Tokyo (JP)

(72) Inventors: Tomonori Yonemoto, Yokohama-shi (JP); Akira Ueno, Tokyo (JP)

(73) Assignee: OLYMPUS CORPORATION, Tokyo (JP)

(21) Appl. No.: 16/197,744

(22) Filed: Nov. 21, 2018

Related U.S. Application Data
(63) Continuation of application No. PCT/JP2017/018923, filed on May 19, 2017.

(30) Foreign Application Priority Data
May 26, 2016 (JP) PCT/JP2016/065589

(51) Int. Cl. G06F 1/06; G06F 1/10

(52) U.S. Cl. CPC G06F 1/06; G06F 1/10

(57) ABSTRACT

A calculation device has a pipeline calculation processing unit having a plurality of calculation circuits, pipeline registers and data selection units connected through a pipeline and configured to perform a calculation with respect to input data and output a calculation result; and a clock supply unit having at least two clock outputs and configured to associate each system with one of the plurality of pipeline registers and supply one or more than one selected clock outputs to the pipeline registers associated with the selected system. The clock supply unit is configured to switch states of each clock output according to an input control signal. The plurality of data selection units are configured to select and output either of output of the pipeline register or output of the calculation circuit according to the control signal.

This application is a continuation application based on a PCT International Application No. PCT/JP2017/018923, filed on May 19, 2017, whose priority is claimed on a PCT International Application No. PCT/JP2016/065589, filed on May 26, 2016. The contents of both PCT International Applications are incorporated herein by reference.

### BACKGROUND OF THE INVENTION

### Field of the Invention

The present invention relates to a calculation device, an image-processing device, and an image-processing method.

### Description of Related Art

In a pipeline calculation processing unit of an image-processing pipeline and the like, a pipeline register is inserted for adjusting timing of a calculation circuit. The pipeline register is inserted in accordance with a maximum operation frequency such that in a mode in which the operation is performed at a low-frequency, the pipeline register becomes an unnecessary element and useless power consumption occurs.

According to a pipeline calculation processing unit disclosed in Japanese Unexamined Patent Application, First Publication No. H6-83583, when a calculation result of a pre-stage calculation circuit is supplied to a post-stage calculation circuit, a selector is provided for switch control of whether or not to interpose a pipeline register between the two circuits. According to this configuration, a suitable number of pipeline stages can be selected in accordance with a clock frequency.

According to the configuration disclosed in Japanese Unexamined Patent Application, First Publication No. H6-83583, a common clock signal is supplied to each pipeline register. A reset signal is supplied to the unused pipeline register such that the unused pipeline register is controlled to perform a reset operation.

### SUMMARY OF THE INVENTION

According to a first aspect of the present invention, a calculation device includes a pipeline calculation processing unit having a plurality of calculation circuits, a plurality of pipeline registers and a plurality of data selection units which are connected through a pipeline, the pipeline calculation processing unit configured to perform a calculation with respect to input data and output a calculation result; and a clock supply unit having at least two clock outputs, the clock supply unit configured to associate each clock output with one of the plurality of pipeline registers and supply one or more than one selected clock outputs to the associated pipeline registers among the plurality of pipeline registers, wherein the clock supply unit is configured to switch states of each clock output according to an input control signal, and wherein the plurality of data selection units are configured to select and output either of output of the pipeline register or output of the calculation circuit according to the control signal.

According to a second aspect of the present invention, the calculation device according to the first aspect may further include a control signal output unit configured to generate and output the control signal for controlling the plurality of data selection units and the clock outputs of the clock supply unit according to an input parameter, wherein the clock supply unit may be configured to stop supplying any clock output in accordance with the control signal.

According to a third aspect of the present invention, in the calculation device according to the second aspect, the parameter may include first information corresponding to a processing amount of the calculation per unit time with respect to the input data, and the control signal output unit may be configured to generate and output the control signal at least according to the first information.

According to a fourth aspect of the present invention, in the calculation device according to the first aspect, the plurality of pipeline registers may be configured to stop operations according to the control signal.

According to a fifth aspect of the present invention, an image-processing device includes a scene recognition unit configured to recognize a scene of input image data and output a recognition result as scene information; a pipeline calculation processing unit having a plurality of calculation circuits, a plurality of pipeline registers and a plurality of data selection units which are connected through a pipeline, the pipeline calculation processing unit configured to perform a calculation with respect to the image data and output a calculation result; a clock supply unit having at least two clock outputs, the clock supply unit configured to associate each clock output with one of the plurality of pipeline registers and supply one or more than one selected clock outputs to the associated pipeline registers among the plurality of pipeline registers; and a control signal output unit configured to generate and output control signal for controlling the plurality of data selection units and clock outputs of the clock supply unit according to the scene information, wherein the clock supply unit is configured to switch states of each clock output according to the control signal, and wherein the plurality of data selection units are configured to select and output either of output of the pipeline register or output of the calculation circuit according to the control signal.

According to a sixth aspect of the present invention, in the image-processing device according to the fifth aspect, the clock supply unit may be configured to stop supplying any clock output in accordance with the control signal.

According to a seventh aspect of the present invention, in the image-processing device according to the fifth aspect, the plurality of pipeline registers may be configured to stop operations according to the control signal.

According to an eighth aspect of the present invention, an image-processing method in an image-processing device having a plurality of calculation circuits, a plurality of pipeline registers, and a plurality of data selection units which are connected through a pipeline, has a step of recognizing a scene of input image data and outputting a recognition result as scene information; a step of performing a calculation with respect to the image data and outputting a calculation result; a step of outputting at least two clock outputs, associating each of at the clock output with one of the plurality of pipeline registers, and supplying one or more than one selected clock outputs to the associated pipeline registers among the plurality of pipeline registers; and a step of generating and outputting control signal for controlling the plurality of data selection units and the clock outputs according to the scene information, wherein states of each clock output are switched according to the control signal, and wherein either of output of the pipeline register or output of the calculation circuit are selected and output according to the control signal.

### BRIEF DESCRIPTION OF DRAWINGS

FIG. 1 is a view showing a configuration according to a first embodiment of the present invention.

FIG. 2 is a view showing a configuration of a pipeline calculation processing unit 11 shown in FIG. 1.

FIG. 3 is a view showing an operation example of the pipeline calculation processing unit 11 shown in FIG. 2.

FIG. 4 is a timing chart showing the operation example of the pipeline calculation processing unit 11 shown in FIG. 3.

FIG. 5 is a view showing an operation example of the pipeline calculation processing unit 11 shown in FIG. 2.

FIG. 6 is a timing chart showing the operation example of the pipeline calculation processing unit 11 shown in FIG. 5.

FIG. 7 is a view showing a configuration according to a second embodiment of the present invention.

FIG. 8 is a view showing a configuration of a pipeline calculation processing unit 11a shown in FIG. 7.

FIG. 9 is a view showing an operation example of the pipeline calculation processing unit 11a shown in FIG. 8.

FIG. 10 is a view showing the operation example of the pipeline calculation processing unit 11a shown in FIG. 8.

FIG. 11 is a view showing the operation example of the pipeline calculation processing unit 11a shown in FIG. 8.

FIG. 12 is a view showing a configuration according to a third embodiment of the present invention.

FIG. 13 is a view showing a pipeline calculation processing unit 11b shown in FIG. 12.

FIG. 14 is a view showing an operation example of the pipeline calculation processing unit 11b shown in FIG. 12.

FIG. 15 is a view showing a configuration according to a fourth embodiment of the present invention.

FIG. 16 is a view showing an operation example of an image-processing device 100b shown in FIG. 15.

FIG. 17 is a view showing a configuration according to a fifth embodiment of the present invention.

FIG. 18 is a view showing a configuration according to a sixth embodiment of the present invention.

FIG. 19 is a view showing a configuration of a calculation processing unit 11c according to a seventh embodiment of the present invention.

FIG. 20 is a timing chart showing the operation example of the pipeline calculation processing unit 11c shown in FIG. 19.

### DETAILED DESCRIPTION OF THE INVENTION

### First Embodiment

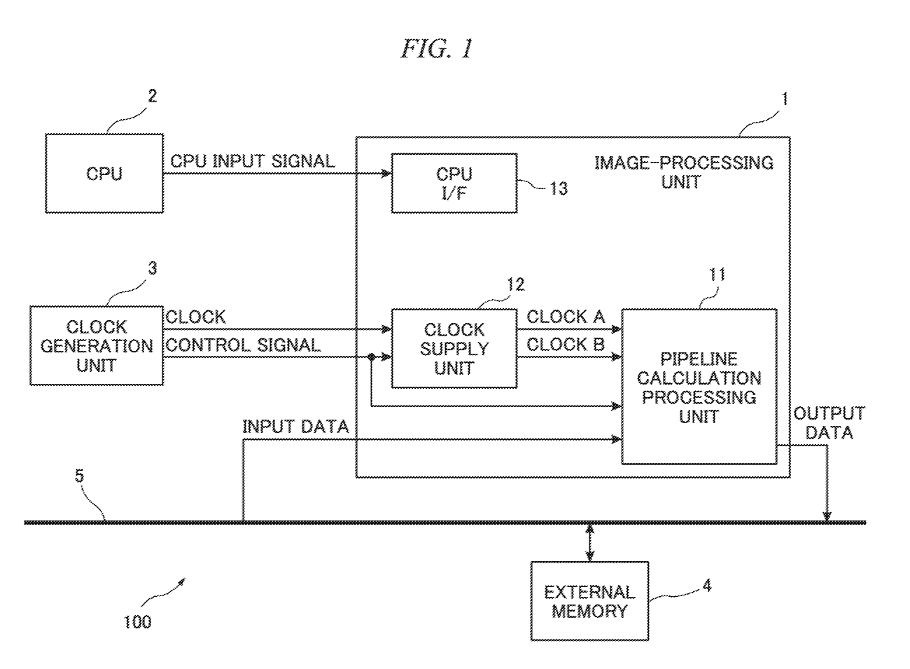

Hereinafter, a first embodiment of the present invention will be described with reference to the accompanying drawings. FIG. 1 is a diagram showing configuration examples of an image-processing unit 1 (calculation device) and an image-processing device 100 according to the first embodiment of the present invention. The image-processing device 100 shown in FIG. 1 includes the image-processing unit 1, a central processing unit (CPU) 2, a clock generation unit 3, an external memory 4, and a bus 5. The CPU 2 controls each unit within the image-processing device 100. The CPU 2 supplies, for example, a signal for control and a signal indicating a parameter which are used in various types of calculation processing by the image-processing unit 1 to the image-processing unit 1 as CPU input signals, or supplies data used as a parameter when the clock generation unit 3 generates a control signal to the clock generation unit 3. The clock generation unit 3 generates and outputs a predetermined clock signal, and generates and outputs a control signal under the control of the CPU 2. The external memory 4, which is a volatile or non-volatile storage device, writes and stores data input through the bus 5 in a storage region or reads out the data stored in the storage region and outputs the read-out data through the bus 5 under the control of the CPU 2. For example, the external memory 4 stores image data captured by an imaging unit of a camera not shown in the drawing, stores a result obtained by performing predetermined calculation processing on the image data, which is captured by the imaging unit, by the image-processing unit 1, or outputs the stored image data to a display unit not shown in the drawing. The bus 5 includes a plurality of address lines, a plurality of data lines, and the like, and is used to transport, for example, data which is input and output between the image-processing unit 1 and the external memory 4. In the present embodiment, as an example, it is assumed that data to be input and output to the image-processing unit 1 is image data.

The image-processing unit 1, which is configured by an application specific integrated circuit (ASIC) or the like, includes a pipeline calculation processing unit 11, a clock supply unit 12, and a CPU interface (I/F) 13.

The pipeline calculation processing unit 11 inputs a CPU input signal through the CPU I/F 13 from the CPU 2. The pipeline calculation processing unit 11 also inputs a clock A and a clock B which are clock outputs of two systems from the clock supply unit 12, and inputs a control signal from the clock generation unit 3. Note that, hereinafter, clock outputs (or clock signals) of a plurality of systems may be referred to as a clock output A, a clock output B, and the like. The pipeline calculation processing unit 11 inputs input data to be processed from the external memory 4 through the bus 5. The pipeline calculation processing unit 11 performs predetermined calculation processing on the input data to be processed which is input from the external memory 4 through the bus 5, outputs a calculation result as output data, and stores the output data in the external memory 4.

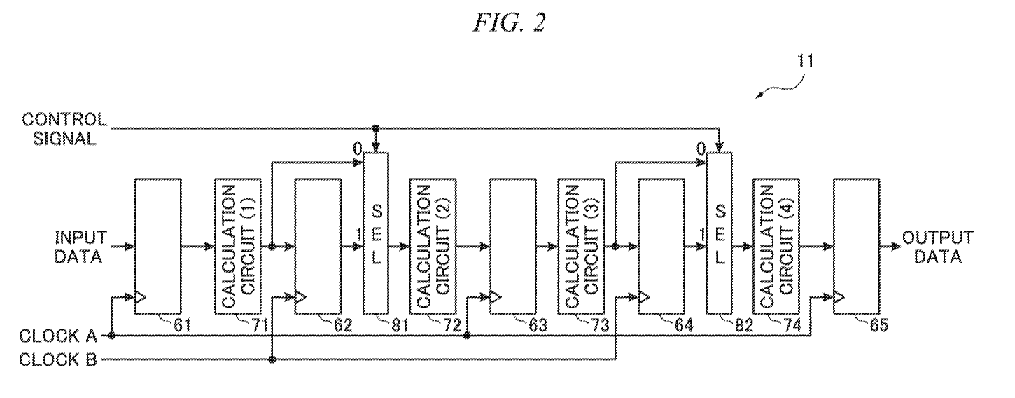

Here, a configuration example of the pipeline calculation processing unit 11 shown in FIG. 1 will be described with reference to FIG. 2. FIG. 2 shows a configuration example of the pipeline calculation processing unit 11 shown in FIG. 1. The pipeline calculation processing unit 11 shown in FIG. 2 includes a pipeline register (1) 61, a pipeline register (2) 62, a pipeline register (3) 63, a pipeline register (4) 64, and a pipeline register (5) 65. The pipeline calculation processing unit 11 also includes a calculation circuit (1) 71, a calculation circuit (2) 72, a calculation circuit (3) 73, and a calculation circuit (4) 74. The pipeline calculation processing unit 11 also includes a selector 81 and selector 82.

The pipeline register (1) 61 to the pipeline register (5) 65, which are configured to include a plurality of bits of flip-flops (D latches), take in, for example, data input to an input terminal in synchronization with the rise of a clock signal input to a clock input terminal and hold and output the taken-in data. Next, the pipeline registers hold the output for a period of time until the clock signal rises.

The calculation circuit (1) 71 to the calculation circuit (4) 74 perform predetermined calculation on the input data, and output calculation results. The calculation circuit (1) 71 to the calculation circuit (4) 74 perform calculation processing such as addition and subtraction processing or remainder calculation processing on input data, for example, using parameters supplied from the CPU 2, parameters determined in advance, parameters stored in a register that is not shown in the drawing, or the like, past calculation results, and the like.

Each of the selectors 81 and 82 includes an input terminal 0, an input terminal 1, and an input terminal for a control signal, outputs data input to the input terminal 0 from an output terminal in a case in which a control signal is “0” (=L level), and outputs data input to the input terminal 1 from an output terminal in a case in which a control signal is “1” (=H level). In this manner, in a case in which outputs of the calculation circuit (1) 71 and the calculation circuit (3) 73 are not processed by the pipeline register (2) 62 and the pipeline register (4) 64, the selector 81 and the selector 82 are switched in accordance with a control signal and the clock supply unit 12 does not output the clock B in accordance with a control signal, so that it is possible to skip the above-described processing. Thus, it is possible to reduce current consumption and to accelerate the processing.

In the example shown in FIG. 2, input data is input to the pipeline register (1) 61 through the bus 5. An output of the pipeline register (1) 61 is input to the calculation circuit (1) 71. An output of the calculation circuit (1) 71 is input to an input terminal of the pipeline register (2) 62 and the input terminal 0 of the selector 81. An output of the pipeline register (2) 62 is input to the input terminal 1 of the selector 81. An output of the selector 81 is input to an input terminal of the calculation circuit (2) 72. An output of the calculation circuit (2) 72 is input to an input terminal of the pipeline register (3) 63. An output of the calculation circuit (3) 73 is input to an input terminal of the pipeline register (4) 64 and the input terminal 0 of the selector 82. An output of the pipeline register (4) 64 is input to the input terminal 1 of the selector 82. An output of the selector 82 is input to an input terminal of the calculation circuit (4) 74. An output of the calculation circuit (4) 74 is input to an input terminal of the pipeline register (5) 65. An output of the pipeline register (5) 65 is input to the external memory 4 and the like through the bus 5.

In addition, the clock A output by the clock supply unit 12 is supplied to clock input terminals of the pipeline register (1) 61, the pipeline register (3) 63, and the pipeline register (5) 65 which are odd stages. The clock B output by the clock supply unit 12 is supplied to clock input terminals of the pipeline register (2) 62 and the pipeline register (4) 64 which are even stages.

As described above, the pipeline calculation processing unit 11 shown in FIG. 2 is configured by the plurality of calculation circuits (1) 71 to (4) 74, the plurality of pipeline registers (1) 61 to (5) 65, and the plurality of selectors 81 and 82 which are connected to each other through pipelines. In addition, the pipeline calculation processing unit 11 performs calculation on input data by a pipeline system, and outputs a calculation result.

As described above, the clocks A and B of two systems which are output by the clock supply unit 12 are selectively supplied to any one of the pipeline registers (1) 61 to (5) 65 associated with the respective systems. In this case, the clock A is supplied to the pipeline registers (1) 61, (3) 63, and (5) 65 which are odd stages in order of connection from an input. In addition, the clock B is supplied to the pipeline registers (2) 62 and (4) 64 which are even stages.

Note that, regarding connection between the clock A and the clock B, the clock A is connected to the odd stage of the pipeline register and the clock B is connected to the even stage thereof. However, the invention is not limited thereto, and each of the clocks may be connected to any pipeline register.

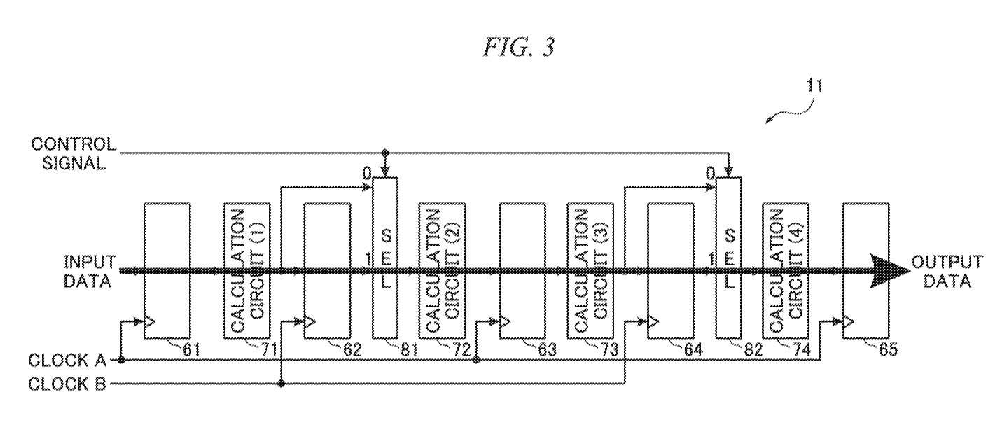

Here, an operation example of the pipeline calculation processing unit 11 shown in FIG. 2 will be described with reference to FIGS. 3 to 6. In addition, the pipeline calculation processing unit 11 is operated in any one of two types of operation modes of a high-speed mode for operating the pipeline registers (1) 61 to (5) 65 at a high speed and a low-speed mode for operating the pipeline registers at low speed. The high-speed mode corresponds to, for example, a movie imaging mode for performing a process of performing image-processing on image data, which is obtained by an imaging unit of a camera and stored in the external memory 4, and storing the processed image data in the external memory 4. On the other hand, for example, the low-speed mode corresponds to a live-view imaging mode for performing a process of performing image-processing on image data, which is obtained by an imaging unit of a camera and stored in the external memory 4, storing the processed image data in the external memory 4, and displaying the image data on a display unit that is not shown in the drawing, in real time. In this case, a frame rate and a resolution of each frame in the movie imaging mode are higher than those in the live-view imaging mode. In this case, it can be said that the operation mode is one of information corresponding to the amount of processing per unit time of calculation performed on input data by the pipeline calculation processing unit 11. In addition, the clock generation unit 3 (control signal output unit) shown in FIG. 1 in the present embodiment generates and outputs a control signal by using information representing an operation mode which is supplied from the CPU 2 or the like as a parameter. The control signal is a signal for controlling a clock output of the clock supply unit 12 and the plurality of selectors 81 and 82 (data selection units).

<Movie Imaging Mode (High-Speed Mode)>

In addition, as shown in Table 1, frequencies of the clock A and the clock B are 500 MHz, the clock A is supplied to the pipeline registers (1) 61, (3) 63, and (5) 65 which are odd stages of the pipeline calculation processing unit 11 (the clock A is in an “ON” state), and the clock B is supplied to the pipeline registers (2) 62 and (4) 64 which are even stages (the clock B is in an “ON” state). The clock A and the clock B are synchronized signals having the same cycle. However, an output stage of a clock signal of the clock supply unit 12 and a wiring from the output stage to the pipeline registers (1) 61 to (5) 65 are different for each system. In addition, a control signal is “1”.

TABLE 1

| OPERATION | OPERATION | | | CONTROL |
|---|---|---|---|---|
| MODE | FREQUENCY | CLOCK A | CLOCK B | SIGNAL |
| VIDEO | 500 MHz | ON | ON | 1 |
| SHOOTING | | | | |
| (4K) | | | | |

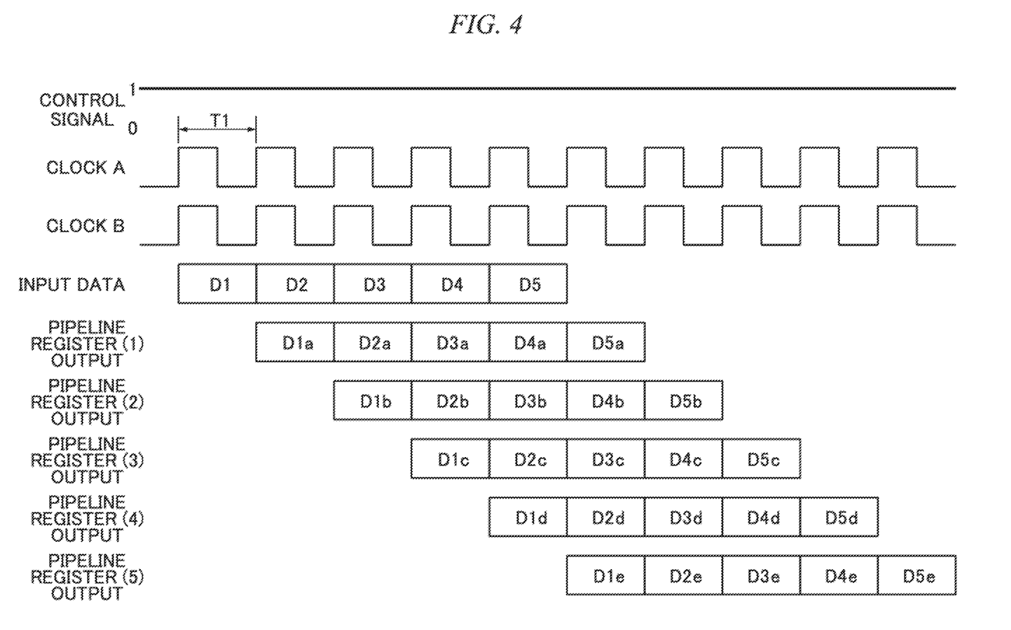

Since the control signal is “1” in the movie imaging mode, the selectors 81 and 82 output data input to the input terminal 1 as shown in FIG. 3, and thus a flow of the data is a flow passing through all of the pipeline registers (1) 61 to (5) 65 which are odd and even stages as indicated by an arrow of a thick line. In addition, the pipeline registers (1) 61 to (5) 65 change input and output data as shown in FIG. 4. FIG. 4 shows changes with time of a control signal, a clock A, a clock B, input data, and outputs of the pipeline registers (1) 61 to (5) 65 with time. One cycle T1 of each of the clock A and the clock B is 2 ns (=1/(500 MHz)). Pieces of data D1a to D5a are pieces of data obtained by delaying pieces of input data D1 to D5 by one clock. Results obtained by performing calculation processing on the data D1a to D5a by the calculation circuit (1) 71 are pieces of data D1b to D5b. Results obtained by performing calculation processing on the data D1b to D5b by the calculation circuit (2) 72 are pieces of data D1c to D5c. Results obtained by performing calculation processing on the data D1c to D5c by the calculation circuit (3) 73 are pieces of data D1d to D5d. In addition, results obtained by performing calculation processing on the data D1d to D5d by the calculation circuit (4) 74 are pieces of data D1e to D5e.

<Live-View Imaging Mode (Low-Speed Mode)>

In this case, as shown in Table 2, the clock A having a frequency of 250 MHz is supplied to the pipeline registers (1) 61, (3) 63, and (5) 65 which are odd stages of the pipeline calculation processing unit 11 (the clock A is in an “ON” state), and the clock B is not supplied to the pipeline registers (2) 62 and (4) 64 which are even stages (the clock B is in an “OFF” state). In addition, a control signal is “0”.

TABLE 2

| OPERATION | OPERATION | | | CONTROL |
|---|---|---|---|---|
| MODE | FREQUENCY | CLOCK A | CLOCK B | SIGNAL |
| LIVE VIEW | 250 MHz | ON | OFF | 0 |
| SHOOTING | | | | |

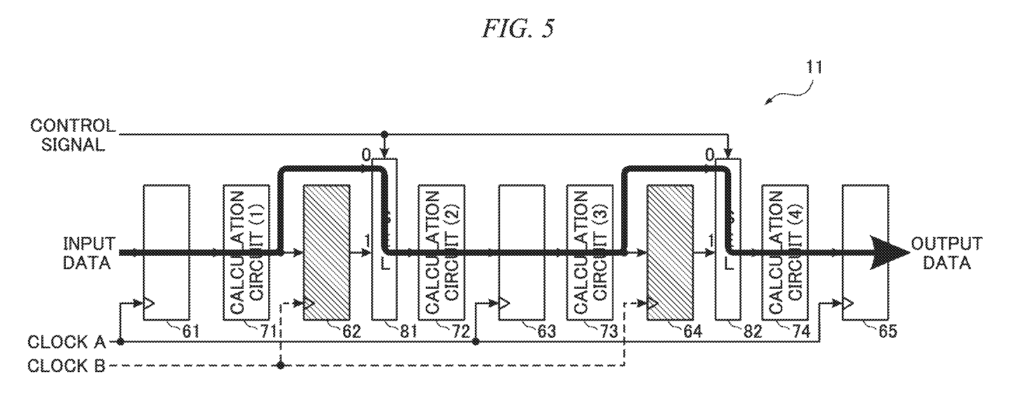

Since the control signal is “0” in the live-view imaging mode, the selectors 81 and 82 output an output of the calculation circuit (1) 71 and an output of the calculation circuit (3) 73 which are input to the input terminal 0 as shown in FIG. 5 from the respective output terminals, and thus the data flows through the pipeline register (1) 61, the calculation circuit (1) 71, the calculation circuit (2) 72, the pipeline register (3) 63, the calculation circuit (3) 73, the calculation circuit (4) 74, and the pipeline register (5) 65 in this order as indicated by an arrow of a thick line. In this case, regarding the pipeline registers (2) 62 and (4) 64 which are hatched and not required to be operated, the supply of a clock is stopped from the root of the clock B as indicated by an arrow of a dashed line, and thus it is possible to reduce power consumption due to a clock tree.

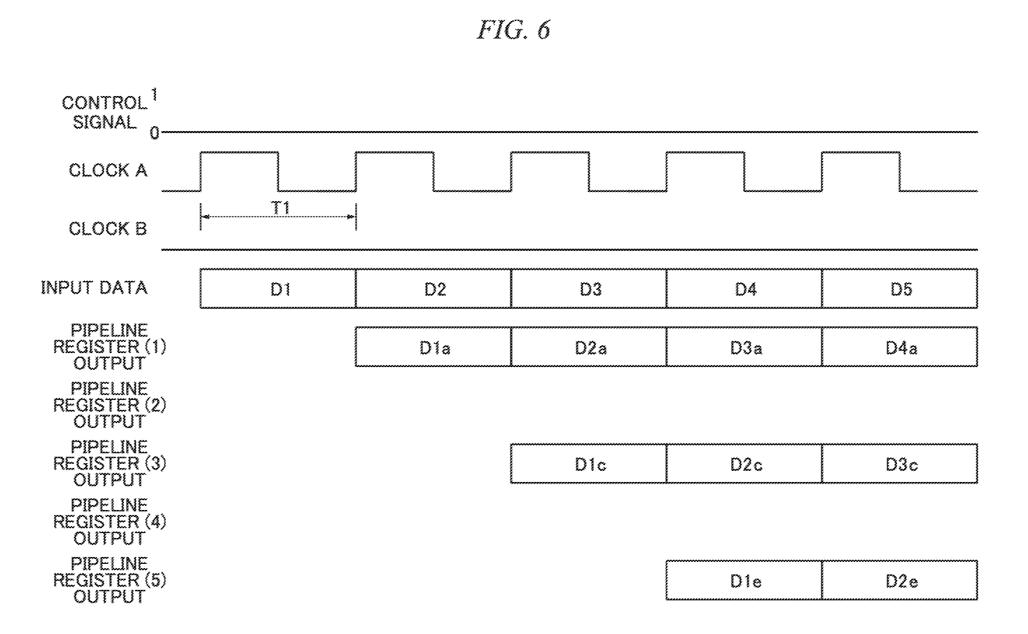

In addition, the pipeline registers (1) 61 to (5) 65 changes input and output data as shown in FIG. 6. FIG. 6 shows changes with time in a control signal, a clock A, a clock B, input data, and outputs of the pipeline registers (1) 61 to (5) 65. One cycle T1 of the clock A is 4 ns (=1/(250 MHz)). Pieces of data D1a to D4a are pieces of data obtained by delaying pieces of input data D1 to D4 by one clock. Results obtained by sequentially performing calculation processing on the data D1a to D4a by the calculation circuit (1) 71 and the calculation circuit (2) 72 are pieces of data D1c to D4c (here, the data D4c is not shown in the drawing). Results obtained by sequentially performing calculation processing on the data D1c to D3c by the calculation circuit (3) 73 and the calculation circuit (4) 74 are pieces of data D1e to D3e (here, the data D3e is not shown in the drawing).

Note that the clock supply unit 12 shown in FIG. 1 includes clock outputs A and B of two systems, and supplies a clock output A or clock outputs A and B of a selected one or plurality of systems selected to the pipeline registers (1) 61, (3) 63, and (5) 65 or the pipeline registers (2) 62 and (4) 64 of the corresponding system by associating each of the systems with any one of the pipeline registers (1) 61 to (5) 65. In this case, the clock supply unit 12 switches the state of the clock output for each system on the basis of a control signal input from the clock generation unit 3. Here, the switching of the state of the clock output includes the change of an output of a clock signal to an on-state or an off-state and the change of a clock frequency. Further, in a case in which the clock supply unit 12 turns off a clock output, that is, stops the supply of a clock output, for example, it is possible to reduce power for charging and discharging the capacity of a clock input stage of a pipeline register of a stopped system or a wiring of a clock signal.

As described above, according to the first embodiment, it is possible to perform a pipeline operation with an appropriate number of pipeline stages in accordance with a clock frequency to be supplied to the pipeline calculation processing unit 11 and to easily limit power consumption due to an unnecessary pipeline register or the like.

### Second Embodiment

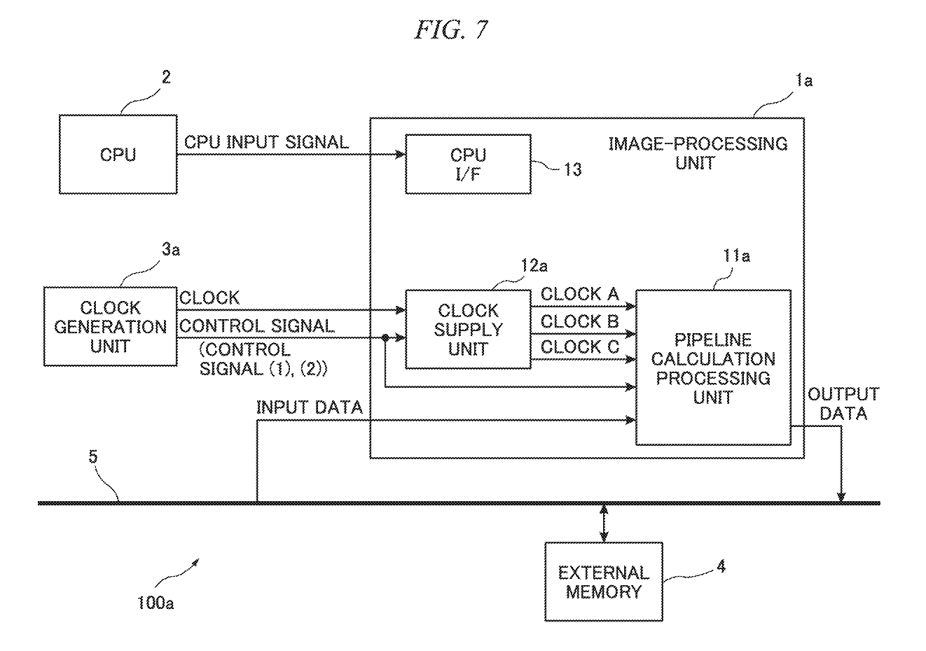

Next, a second embodiment of the present invention will be described with reference to the accompanying drawings. FIG. 7 is a diagram showing configuration examples of an image-processing unit 1a (calculation device) and an image-processing device 100a according to the second embodiment of the present invention. Note that, in FIG. 7, components which are the same as or correspond to those shown in FIG. 1 are denoted by the same reference numerals or the same numerals followed by a letter, and a description thereof will be omitted as appropriate.

The image-processing device 100a shown in FIG. 7 includes an image-processing unit 1a, a CPU 2, a clock generation unit 3a, an external memory 4, and a bus 5. The clock generation unit 3a generates and outputs a predetermined clock signal, and generates and outputs a control signal by using, for example, information representing an operation mode to be supplied from the CPU 2 or the like as a parameter under the control of the CPU 2. In this case, the control signal to be output by the clock generation unit 3a includes two types of control signals of a control signal (1) and a control signal (2). In the present embodiment, data to be input and output is image data.

The image-processing unit 1a includes a pipeline calculation processing unit 11a, a clock supply unit 12a, and a CPU I/F 13. The clock supply unit 12a switches and outputs states of clock signals of three systems of clock outputs A, B, and C on the basis of a control signal and a clock which are input from the clock generation unit 3a.

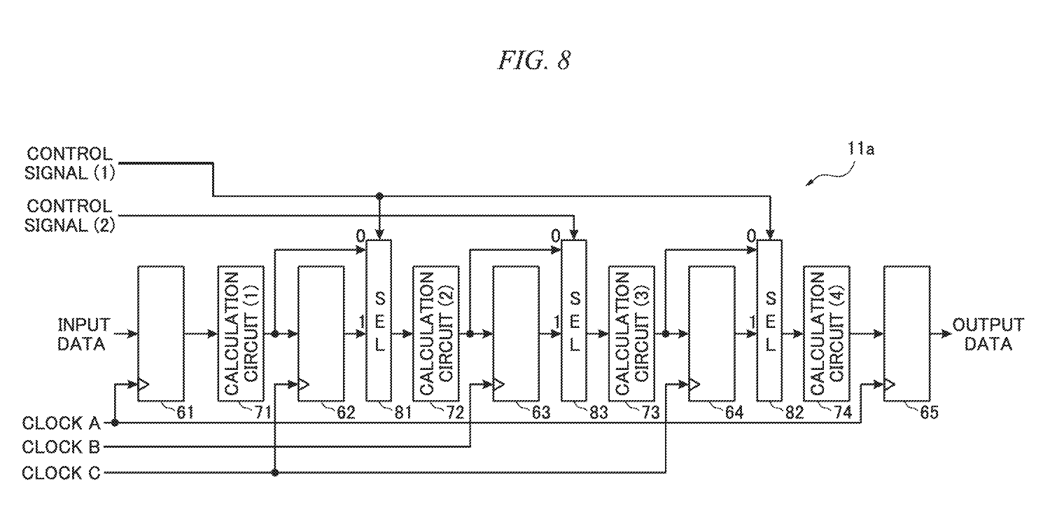

The pipeline calculation processing unit 11a is the same as the pipeline calculation processing unit 11 according to the first embodiment shown in FIG. 2 except that a selector 83 is newly provided for an input and output path of data, as shown in FIG. 8. That is, in the pipeline calculation processing unit 11a, the selector 83 is newly provided between an output of a pipeline register (3) 63 and an input terminal of a calculation circuit (3) 73. An output of a calculation circuit (2) 72 is connected to an input terminal 0 of the selector 83, and an output of the pipeline register (3) 63 is connected to an input terminal 1 of the selector 83.

In addition, a control signal (1) is input to an input terminal of a control signal of each of selectors 81 and 82, and a control signal (2) is input to an input terminal of a control signal of the selector 83. In addition, a clock A is input to a clock input terminal of each of a pipeline register (1) 61 and a pipeline register (5) 65. A clock B is input to a clock input terminal of the pipeline register (3) 63. In addition, a clock C is input to a clock input terminal of each of a pipeline register (2) 62 and a pipeline register (4) 64.

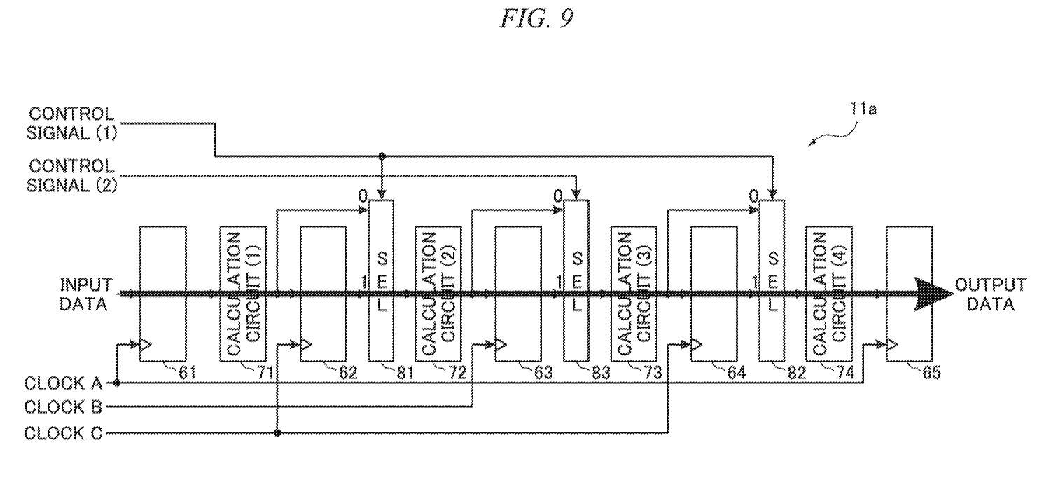

Here, an operation example of the pipeline calculation processing unit 11a shown in FIG. 8 will be described with reference to FIGS. 9 to 11. In this case, the pipeline calculation processing unit 11a is operated in any one of three types of operation modes of a high-speed mode for operating the pipeline registers (1) 61 to (5) 65 at a high speed, a medium-speed mode for operating the pipeline registers at a medium speed, and a low-speed mode for operating the pipeline registers at a low speed. The high-speed mode corresponds to, for example, a movie imaging mode for performing a process of performing image-processing on image data, which is captured by an imaging unit of a camera with a resolution of 4K and stored in an external memory 4, and storing the processed image data in the external memory 4. The medium-speed mode corresponds to, for example, a movie imaging mode for performing a process of performing image-processing on image data, which is captured by an imaging unit of a camera with a resolution of full high definition (full HD) and stored in the external memory 4, and storing the processed image data in the external memory 4. In addition, the low-speed mode corresponds to, for example, a live-view imaging mode for performing a process of performing image-processing on image data, which is captured by an imaging unit of a camera and stored in the external memory 4, storing the processed image data in the external memory 4, and displaying the image data on a display unit in real time. In this case, the frame rate and the resolution of each frame in the movie imaging mode are higher than those in the live-view imaging mode. In addition, the two types of movie imaging modes differ in a resolution. Therefore, in this case, it can be said that an operation mode including a high-speed mode, a medium-speed mode, and a low-speed mode is one of information corresponding to the amount of processing per unit time of calculation performed on input data by the pipeline calculation processing unit 11a. Further, in the present embodiment, the clock generation unit 3a (control signal output unit) shown in FIG. 7 generates and outputs a control signal by using information representing an operation mode which is input from the CPU 2 or the like as a parameter. The control signal is a signal for controlling a clock output of the clock supply unit 12a and the plurality of selectors 81, 82, and 83 (data selection units).

<Movie Imaging Mode (4K) (High-Speed Mode)>

In addition, as shown in Table 3, frequencies of a clock A, a clock B, and a clock C are 500 MHz, and all of the clocks A to C are set to be in an “ON” state. The clocks A to C are synchronized signals having the same cycle. In addition, both of the control signals (1) and (2) are “1”. Note that a processing size is 3840 pixels×2160 pixels.

TABLE 3

| | | | | | | CONTROL | |
|---|---|---|---|---|---|---|---|
| OPERATION | PROCESSING | OPERATION | | | | SIGNAL | |
| MODE | SIZE | FREQUENCY | CLOCK A | CLOCK B | CLOCK C | (1) | (2) |
| VIDEO | 3840 × 2160 | 500 MHz | ON | ON | ON | 1 | 1 |
| SHOOTING | | | | | | | |
| (4K) | | | | | | | |
| VIDEO | 1920 × 1080 | 350 MHz | ON | ON | OFF | 0 | 1 |
| SHOOTING | | | | | | | |
| (FULL HD) | | | | | | | |
| LIVE VIEW | 640 × 480 | 250 MHz | ON | OFF | OFF | 0 | 0 |
| SHOOTING | | | | | | | |

In a movie imaging mode (4K), the control signals (1) and (2) are “1”, and thus the selectors 81 to 83 output data which is input to the input terminal 1 as shown in FIG. 9. Therefore, a flow of the data is a flow passing through all of the pipeline registers (1) 61 to (5) 65 as indicated by an arrow of a thick line.

<Movie Imaging Mode (Full HD) (Medium-Speed Mode)>

In addition, as shown in Table 3, frequencies of the clock A and the clock B are 350 MHz, the clocks A and B are set to be in an “ON” state and the clock C is set to be in an “OFF”. The clocks A and B are synchronized signals having the same cycle. In addition, the control signal (1) is “0”, and the control signal (2) is “1”. Note that a processing size is 1920 pixels×1080 pixels.

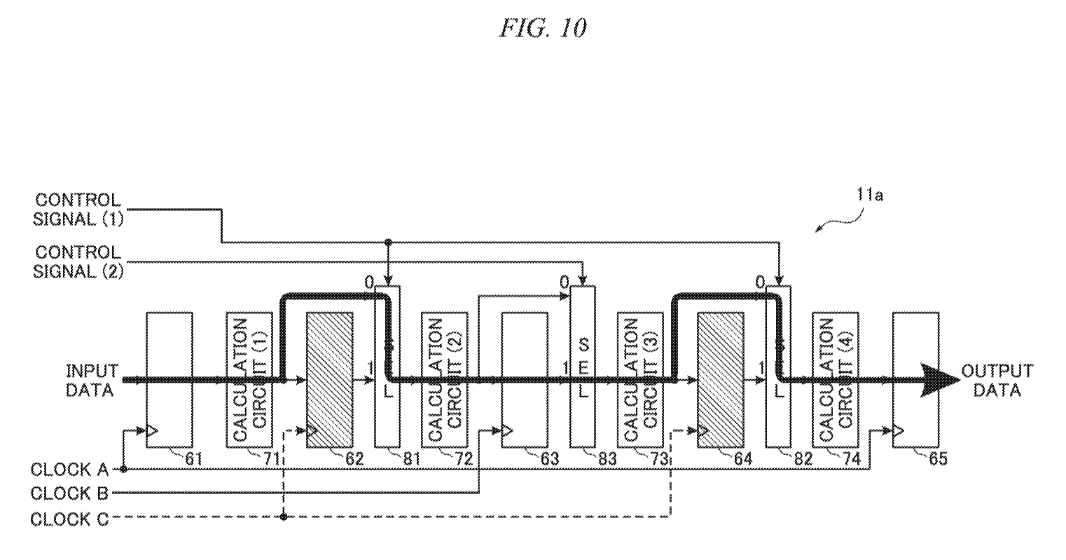

In a movie imaging mode (full HD), the control signal (1) is “0” and the control signal (2) is “1”, and thus the selectors 81 and 82 output data which is input to an input terminal 0 and the selector 83 outputs data which is input to an input terminal 1 as shown in FIG. 10. Therefore, the data flows through the pipeline register (1) 61, the calculation circuit (1) 71, the calculation circuit (2) 72, the pipeline register (3) 63, the calculation circuit (3) 73, the calculation circuit (4) 74, and the pipeline register (5) 65 in this order as indicated by an arrow of a thick line. In this case, regarding the pipeline registers (2) 62 and (4) 64 which are hatched and not required to be operated, the supply of a clock is stopped from the root of the clock C as indicated by an arrow of a dashed line, and thus it is possible to reduce power consumption due to a clock tree.

<Live-View Imaging Mode (Low-Speed Mode)>

In addition, as shown in Table 3, the frequency of the clock A is 250 MHz, the clock A is set to be in an “ON” state, and the clocks B and C are set to be in an “OFF” state. In addition, both the control signals (1) and (2) are “0”. Note that a processing size is 640 pixels×480 pixels.

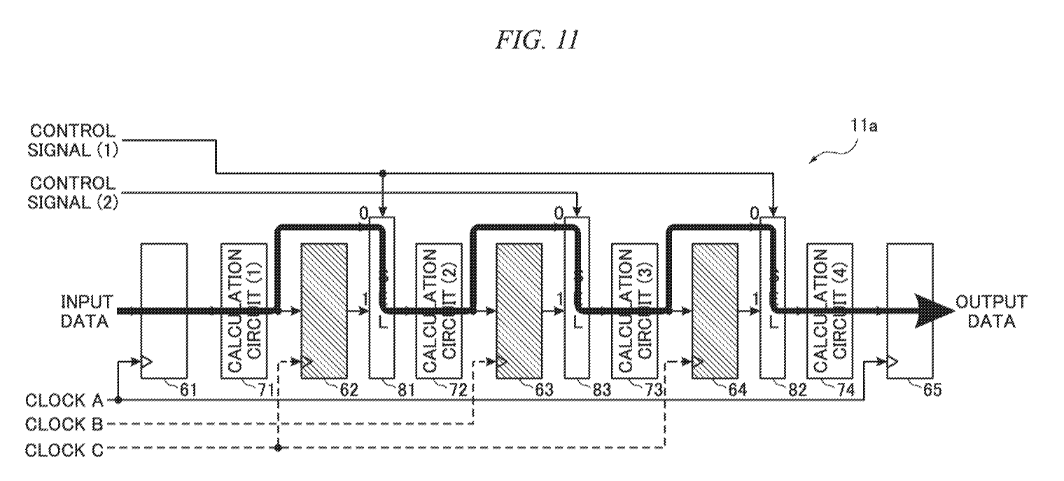

In a live-view imaging mode, the control signals (1) and (2) are “0”, and thus the selectors 81 to 83 output data which is input to an input terminal 0 as shown in FIG. 11. Therefore, the data flows through the pipeline register (1) 61, the calculation circuit (1) 71, the calculation circuit (2) 72, the calculation circuit (3) 73, the calculation circuit (4) 74, and the pipeline register (5) 65 in this order as indicated by an arrow of a thick line. In this case, regarding the pipeline registers (2) 62, (3) 63, and (4) 64 which are hatched and not required to be operated, the supply of a clock is stopped from the roots of the clocks B and C as indicated by an arrow of a dashed line, and thus it is possible to reduce power consumption due to a clock tree.

As described above, according to the second embodiment, systems of clocks are set to be three systems, and thus it is possible to perform a pipeline operation with an appropriate number of pipeline stages in accordance with a clock frequency to be supplied to the pipeline calculation processing unit 11a and to easily limit power consumption due to an unnecessary pipeline register or the like.

### Third Embodiment

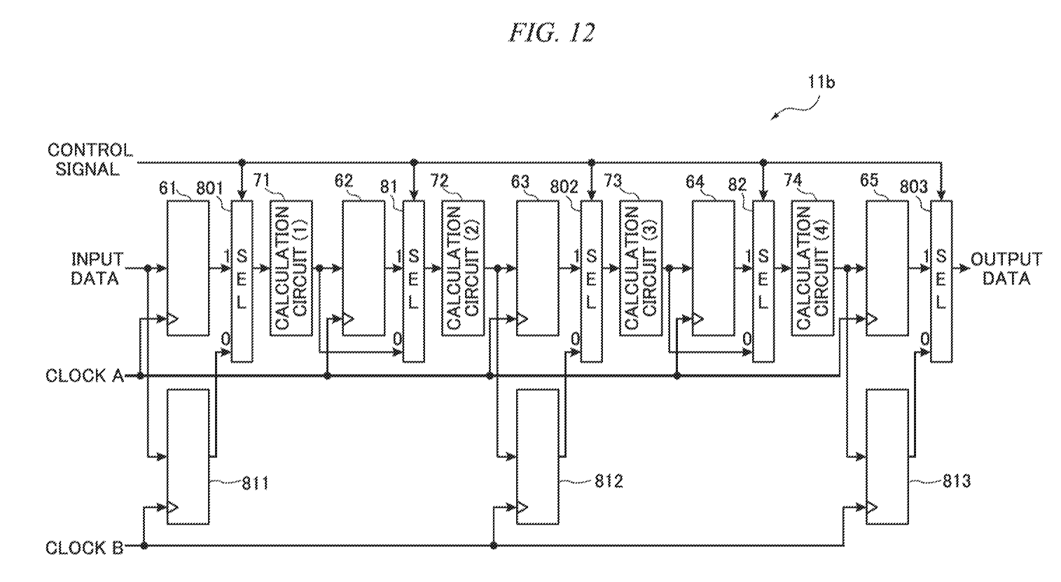

Next, a third embodiment of the present invention will be described with reference to the accompanying drawings. FIG. 12 shows a configuration example of a pipeline calculation processing unit 11b. The pipeline calculation processing unit 11b has a configuration in which a portion of the pipeline calculation processing unit 11 according to the first embodiment shown in FIG. 2 is modified. Note that input and output signals (data, clocks, and a control signal) of the pipeline calculation processing unit 11b shown in FIG. 12 are the same as the input and output signals of the pipeline calculation processing unit 11 shown in FIG. 2. The pipeline calculation processing unit 11b shown in FIG. 12 newly includes three selectors 801 to 803 and three pipeline registers (11) 811 to (13) 813, as compared to the pipeline calculation processing unit 11 according to the first embodiment shown in FIG. 2.

Input data is input to an input terminal of the pipeline register (11) 811, similar to a pipeline register (1) 61. An output of the pipeline register (11) 811 is input to an input terminal 0 of the selector 801, and an output of the pipeline register (1) 61 is input to an input terminal 1 of the selector 801. An output of the selector 801 is input to an input terminal of the calculation circuit (1) 71.

An output of the calculation circuit (1) 71 is input to an input terminal of a pipeline register (2) 62 and is input to an input terminal 0 of the selector 81. An output of the pipeline register (2) 62 is input to an input terminal 1 of the selector 81. An output of the selector 81 is input to an input terminal of the calculation circuit (2) 72.

An output of the calculation circuit (2) 72 is input to an input terminal of the pipeline register (12) 812, similar to a pipeline register (3) 63. An output of the pipeline register (12) 812 is input to an input terminal 0 of the selector 802, and an output of the pipeline register (3) 63 is input to an input terminal 1 of the selector 802. An output of the selector 802 is input to an input terminal of the calculation circuit (3) 73.

An output of the calculation circuit (3) 73 is input to an input terminal of a pipeline register (4) 64 and is input to an input terminal 0 of the selector 82. An output of the pipeline register (4) 64 is input to an input terminal 1 of the selector 82. An output of the selector 82 is input to an input terminal of the calculation circuit (4) 74.

An output of the calculation circuit (4) 74 is input to an input terminal of the pipeline register (13) 813, similar to a pipeline register (5) 65. An output of the pipeline register (13) 813 is input to an input terminal 0 of the selector 803, and an output of the pipeline register (5) 65 is input to an input terminal 1 of the selector 803. An output of the selector 803 is output data.

A control signal output by the clock generation unit 3 shown in FIG. 1 is input to an input terminal of a control signal of each of the selectors 801 to 803, similar to the selectors 81 and 82. A clock A is supplied to a clock input terminal of each of the pipeline registers (1) 61 to (5) 65 from the clock supply unit 12 shown in FIG. 1. A clock B is supplied to a clock input terminal of each of the pipeline registers (11) 811 to (13) 813 from the clock supply unit 12 shown in FIG. 1.

The pipeline calculation processing unit 11b shown in FIG. 12 supplies a clock A to all of the pipeline registers (1) 61 to (5) 65 included in the pipeline calculation processing unit 11 shown in FIG. 2 in common, and supplies a clock B to all of the pipeline registers (11) 811 to (13) 813, which are newly provided, in common.

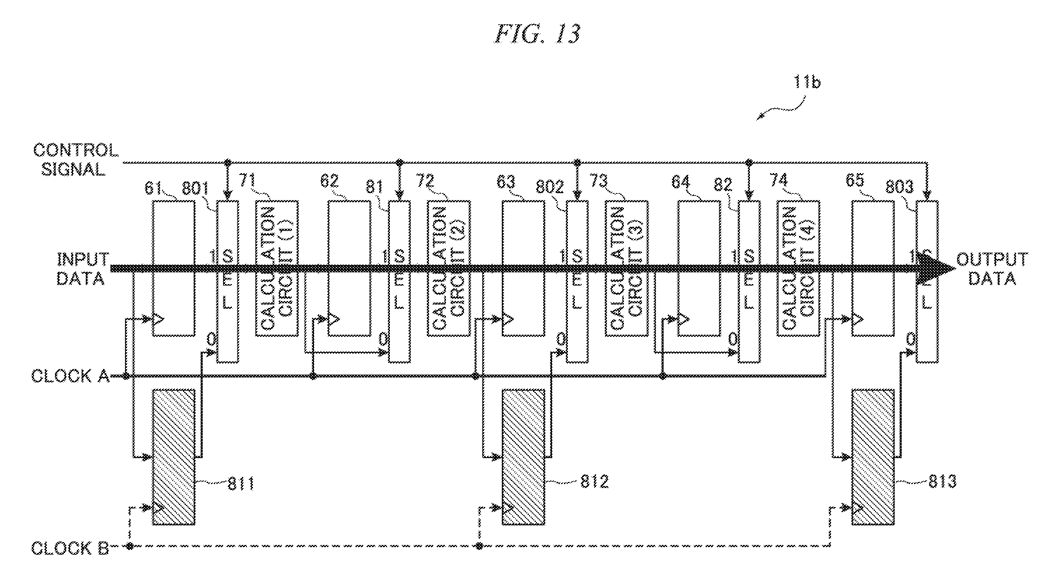

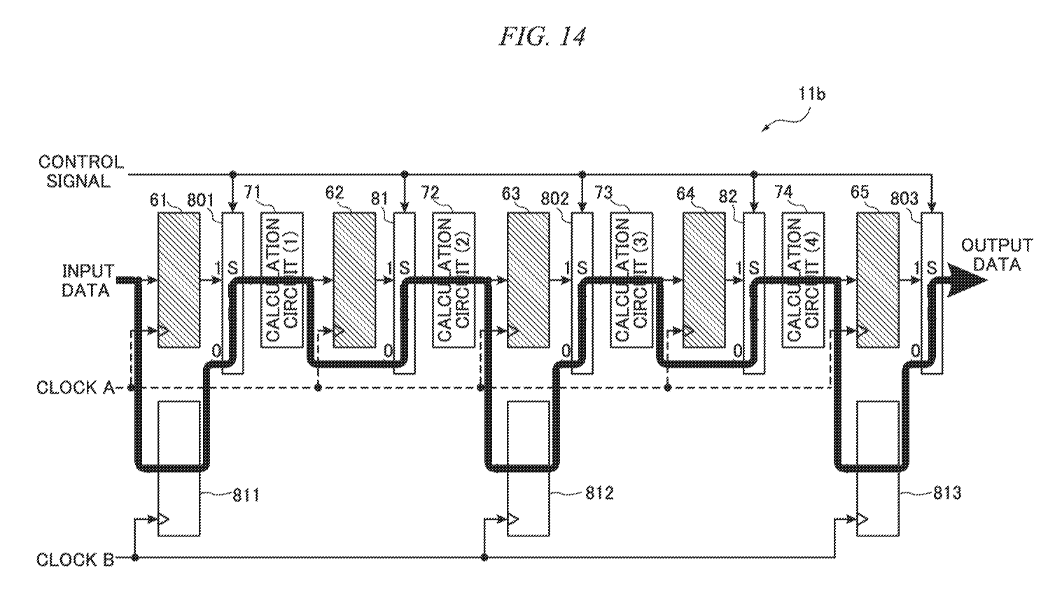

Next, an operation example of the pipeline calculation processing unit 11b shown in FIG. 12 will be described with reference to FIGS. 13 and 14. In this operation example, the pipeline calculation processing unit 11b is operated, for example, in any one of two types of operation modes of a movie imaging mode and a live-view imaging mode, similar to the first embodiment. However, the pipeline calculation processing unit 11b according to the third embodiment and the pipeline calculation processing unit 11 according to the first embodiment differ in the control of turn-on and turn-off of the clocks A and B.

<Movie Imaging Mode (High-Speed Mode)>

In this case, as shown in Table 4, frequencies of the clock A and the clock B are 500 MHz, the clock A is supplied to the pipeline registers (1) 61 to (5) 65 of the pipeline calculation processing unit 11b (the clock A is in an “ON” state), and the supply of the clock B to the pipeline registers (11) 811 to (13) 813 is stopped (the clock B is in an “OFF” state). In addition, a control signal is “1”.

TABLE 4

| OPERATION | OPERATION | | | CONTROL |
|---|---|---|---|---|
| MODE | FREQUENCY | CLOCK A | CLOCK B | SIGNAL |
| VIDEO | 500 MHz | ON | OFF | 1 |
| SHOOTING | | | | |
| (4K) | | | | |

Since the control signal is “1” in the movie imaging mode, the selectors 81 and 82 and the selectors 801 to 803 output data which is input to the input terminal 1 as shown in FIG. 13. Therefore, a flow of the data is a flow passing through the pipeline registers (1) 61 to (5) 65 as indicated by an arrow of a thick line. In this case, regarding the pipeline registers (11) 811 to (13) 813 which are hatched and not required to be operated, the supply of a clock is stopped from the root of the clock B as indicated by an arrow of a dashed line, and thus it is possible to reduce power consumption due to a clock tree.

<Live-View Imaging Mode (Low-Speed Mode)>

In addition, as shown in Table 5, the clock B having a frequency of 250 MHz is supplied to the pipeline registers (11) 811 to (13) 813 of the pipeline calculation processing unit 11b (the clock B is in an “ON” state), and the clock A is not supplied to the pipeline registers (1) 61 to (5) 65 (the clock A is in an “OFF” state). In addition, a control signal is “0”.

TABLE 5

| OPERATION | OPERATION | | | CONTROL |
|---|---|---|---|---|
| MODE | FREQUENCY | CLOCK A | CLOCK B | SIGNAL |
| LIVE VIEW | 250 MHz | OFF | ON | 0 |
| SHOOTING | | | | |

Since the control signal is “0” in the live-view imaging mode, the selectors 81 and 82 and the selectors 801 to 803 output data which is input to the input terminal 0 as shown in FIG. 14. Therefore, the data flows through the pipeline register (11) 811, the calculation circuit (1) 71, the calculation circuit (2) 72, the pipeline register (12) 812, the calculation circuit (3) 73, the calculation circuit (4) 74, and the pipeline register (13) 813 in this order as indicated by an arrow of a thick line. In this case, regarding the pipeline registers (1) 61 to (5) 65 which are hatched and not required to be operated, the supply of a clock is stopped from the root of the clock A as indicated by an arrow of a dashed line, and thus it is possible to reduce power consumption due to a clock tree.

As described above, according to the third embodiment, it is possible to perform a pipeline operation with an appropriate number of pipeline stages in accordance with a clock frequency to be supplied to the pipeline calculation processing unit 11b and to easily limit power consumption due to an unnecessary pipeline register or the like.

### Fourth Embodiment

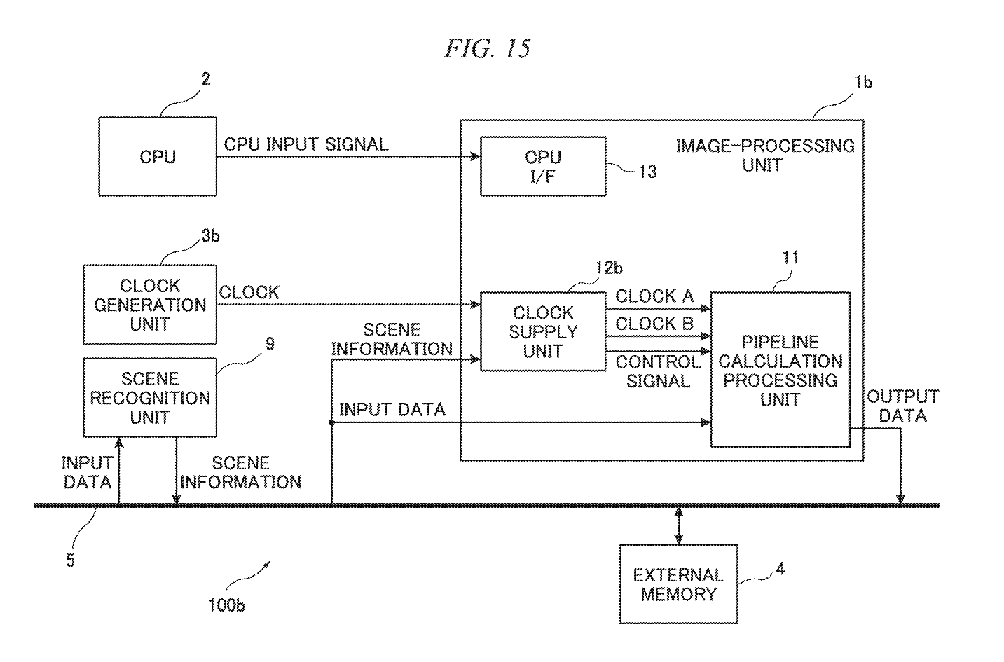

Next, a fourth embodiment of the present invention will be described with reference to the accompanying drawings. FIG. 15 is a diagram showing configuration examples of an image-processing unit 1b (calculation device) and an image-processing device 100b according to the fourth embodiment of the present invention. Note that, in FIG. 15, components which are the same as or correspond to those shown in FIG. 1 are denoted by the same reference numerals or the same numerals followed by a letter, and a description thereof will be omitted as appropriate.

The image-processing device 100b shown in FIG. 15 includes an image-processing unit 1b, a CPU 2, a clock generation unit 3b, an external memory 4, a bus 5, and a scene recognition unit 9. The scene recognition unit 9, which is a component newly provided in the fourth embodiment, inputs image data stored in an external memory 4 as input data, generates scene information for one or a plurality of frames, and writes the generated scene information back to the external memory 4 in association with the image data. The scene information is, for example, information for identifying four types of scenes shown in Table 6. In addition, the four types of scenes are scenes of scenery (town), an animal, landscape (sky), and still life. A feature of the scenery (town) scene is that the scene includes many high-frequency components. A feature of the animal scene is that a subject moves a lot. Features of the landscape (sky) and still life scenes are that a subject moves a little. The scene recognition unit 9 extracts features of image data and recognizes the type of scene by analyzing a motion vector between frames or analyzing a frequency component. The scene recognition unit 9 generates and outputs by using information for identifying the recognized type of scene as scene information. Note that the type of scene is not limited to the scenes shown in Table 6.

TABLE 6

| | | CLOCK | CLOCK | CONTROL |
|---|---|---|---|---|
| SCENE | CHARACTERISTIC | A | B | SIGNAL |
| LANDSCAPE | MANY HIGH | ON | ON | 1 |
| (CITY) | FREQUENCY | | | |
| | COMPONENTS | | | |
| | INCLUDED | | | |
| ANIMAL | MUCH | ON | ON | 1 |
| | MOVEMENTS OF | | | |
| | SUBJECT | | | |
| LANDSCAPE | SLIGHT | ON | OFF | 0 |
| (SKY) | MOVEMENTS OF | | | |
| | SUBJECT | | | |
| STILL LIFE | MUCH | ON | OFF | 0 |
| | MOVEMENTS OF | | | |
| | SUBJECT | | | |

On the other hand, the image-processing unit 1b includes a pipeline calculation processing unit 11, a clock supply unit 12b, and a CPU I/F 13. The pipeline calculation processing unit 11 is the same as the pipeline calculation processing unit 11 according to the first embodiment shown in FIGS. 1 and 2. The clock supply unit 12b inputs a clock which is generated and output by the clock generation unit 3b, inputs scene information from the external memory 4, generates a clock A and a clock B, and supplies the generated clocks A and B to the pipeline calculation processing unit 11b, similar to the clock supply unit 12 shown in FIG. 1. In this case, the clock supply unit 12b inputs scene information which is generated by the scene recognition unit 9 and written in the external memory 4, generates and outputs a control signal as shown in Table 6 on the basis of the input scene information, and generates and outputs or stops clocks A and B, unlike the clock supply unit 12 shown in FIG. 1.

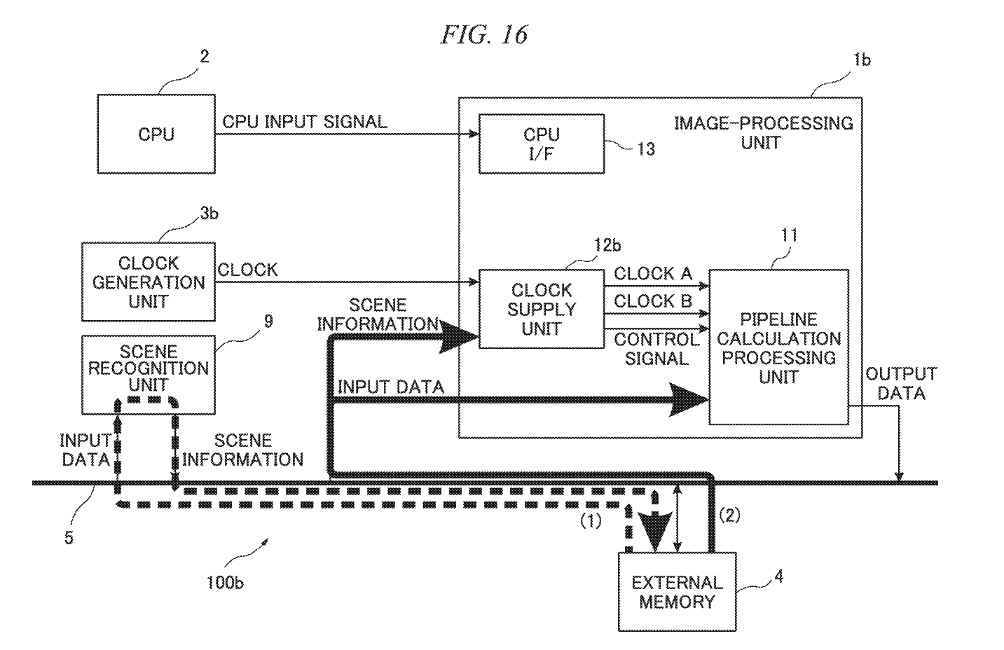

Next, an operation example of the image-processing device 100b shown in FIG. 15 will be described with reference to FIG. 16. The image-processing device 100b shown in FIG. 15 repeats the next procedures (1) and (2) of two stages to execute calculation processing. That is, (1) first, the scene recognition unit 9 acquires input data from the external memory 4, generates scene information, and writes the generated scene information back to the external memory 4. In addition, data flows as indicated by an arrow of a thick dashed line in FIG. 16. (2) Next, the image-processing unit 1b acquires the scene information and input data from the external memory 4. The clock supply unit 12b supplies clocks generated and output by the clock generation unit 3b to the pipeline calculation processing unit 11 as clocks A and B in accordance with the scene information or stops the supply of the clocks, and generates and outputs a control signal. The pipeline calculation processing unit 11 executes calculation processing similar to the first embodiment on the basis of the clocks A and B and the control signal supplied from the clock supply unit 12b. In addition, data is input to the image-processing unit 1b as indicated by an arrow of a thick line in FIG. 16.

As described above, in the fourth embodiment, the clock supply unit 12b (a clock supply unit and a control signal output unit) itself generates and outputs a clock output of the clock supply unit 12b and a control signal for controlling a plurality of selectors 81 and 82 on the basis of scene information. Further, in the fourth embodiment, similarly to the first embodiment, it is possible to perform a pipeline operation with an appropriate number of pipeline stages in accordance with a clock frequency to be supplied to the pipeline calculation processing unit 11 and to easily limit power consumption due to an unnecessary pipeline register or the like.

Further, in the fourth embodiment, the clock supply unit 12b generates and outputs a control signal by using scene information input from the external memory 4 as a parameter, and controls the state of a clock output.

### Fifth Embodiment

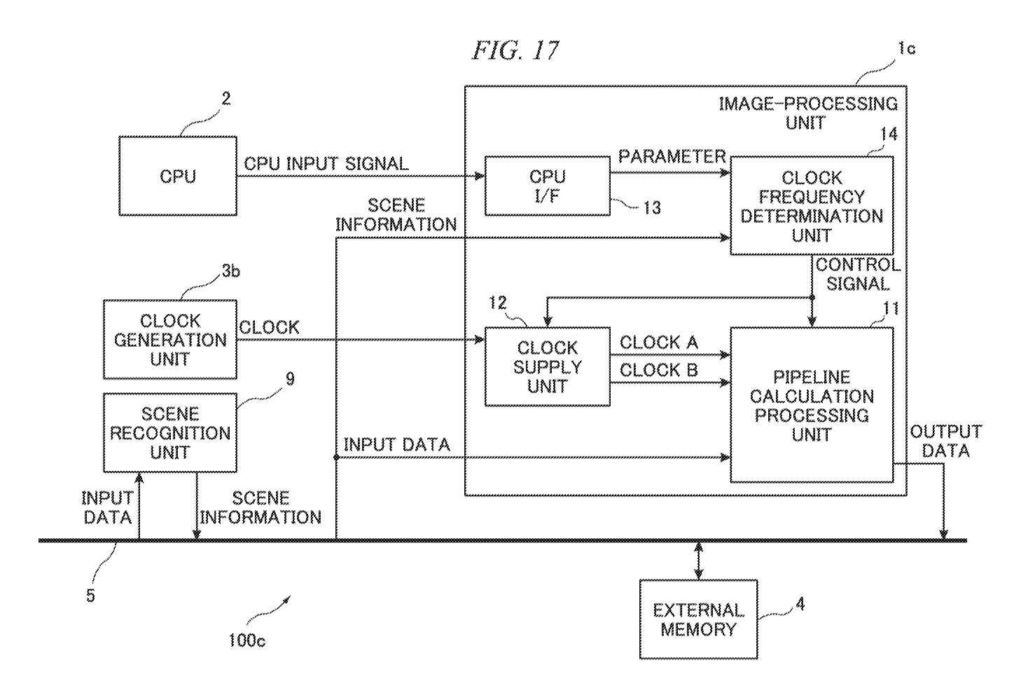

Next, a fifth embodiment of the present invention will be described with reference to FIG. 17. FIG. 17 is a diagram showing configuration examples of an image-processing unit 1c (calculation device) and an image-processing device 100c according to the fifth embodiment of the present invention. Note that, in FIG. 17, components which are the same as or correspond to those shown in FIG. 15 are denoted by the same reference numerals, and a description thereof will be omitted. The image-processing device 100c according to the fifth embodiment is different from the image-processing device 100b according to the fourth embodiment in a configuration of the image-processing unit 1c which is a component corresponding to the image-processing unit 1b shown in FIG. 15. That is, the image-processing unit 1c shown in FIG. 17 newly includes a clock frequency determination unit 14 (control signal output unit). The clock frequency determination unit 14 generates a control signal on the basis of scene information acquired from the external memory 4 and various parameters supplied from the CPU 2, and supplies the generated control signal to the clock supply unit 12 and the pipeline calculation processing unit 11. Configurations of the clock supply unit 12 and the pipeline calculation processing unit 11 are the same as the configurations of the clock supply unit 12 and the pipeline calculation processing unit 11 according to the first embodiment shown in FIGS. 1 and 2.

According to the fifth embodiment, similarly to the fourth embodiment, a control signal for controlling a clock output of the clock supply unit 12 and the plurality of selectors 81 and 82 is generated and output on the basis of scene information. In addition, according to the fifth embodiment, similarly to the first embodiment, it is possible to perform a pipeline operation with an appropriate number of pipeline stages in accordance with a clock frequency to be supplied to the pipeline calculation processing unit 11 and to easily limit power consumption due to an unnecessary pipeline register or the like.

### Sixth Embodiment

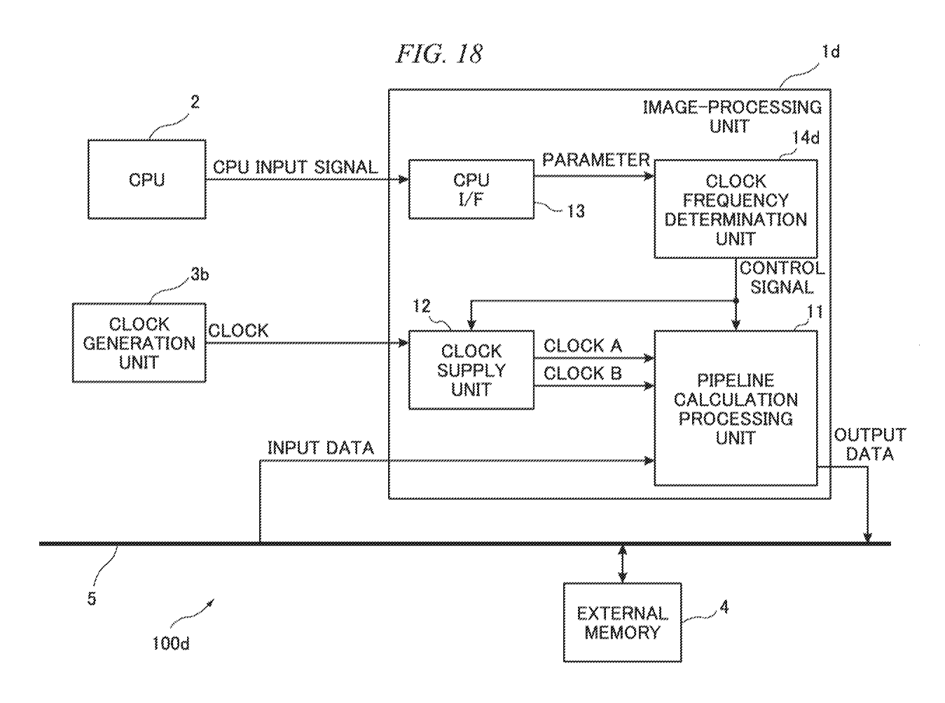

Next, a sixth embodiment of the present invention will be described with reference to FIG. 18. FIG. 18 is a diagram showing configuration examples of an image-processing unit 1d (calculation device) and an image-processing device 100d according to the sixth embodiment of the present invention. Note that, in FIG. 18, components which are the same as or correspond to those shown in FIG. 17 are denoted by the same reference numerals, and a description thereof will be omitted. The image-processing device 100d according to the sixth embodiment is different from the image-processing device 100c according to the fifth embodiment in that the scene recognition unit 9 is omitted and in a configuration of the image-processing unit 1d which is a component corresponding to the image-processing unit 1c shown in FIG. 17. That is, in the image-processing unit 1d shown in FIG. 18, a clock frequency determination unit 14d (control signal output unit) generates a control signal on the basis of various parameters supplied from a CPU 2 and supplies the generated control signal to the clock supply unit 12 and the pipeline calculation processing unit 11. The parameters supplied from the CPU 2 include first information corresponding to the amount of processing per unit time of calculation performed on input data by the pipeline calculation processing unit 11. The first information is, for example, information representing operation modes of an imaging unit as shown in Table 3. The clock frequency determination unit 14d can generate and output a control signal on the basis of at least the first information. Note that configurations of the clock supply unit 12 and the pipeline calculation processing unit 11 are the same as the configurations of the clock supply unit 12 and the pipeline calculation processing unit 11 according to the first embodiment shown in FIGS. 1 and 2.

According to the sixth embodiment, the clock frequency determination unit 14d generates and outputs a control signal for controlling a clock output and a plurality of selectors 81 and 82 to the clock supply unit 12 and the pipeline calculation processing unit 11 on the basis of various parameters supplied from the CPU 2. In addition, according to the sixth embodiment, similarly to the first embodiment, it is possible to perform a pipeline operation with an appropriate number of pipeline stages in accordance with a clock frequency to be supplied to the pipeline calculation processing unit 11 and to easily limit power consumption due to an unnecessary pipeline register or the like.

### Seventh Embodiment

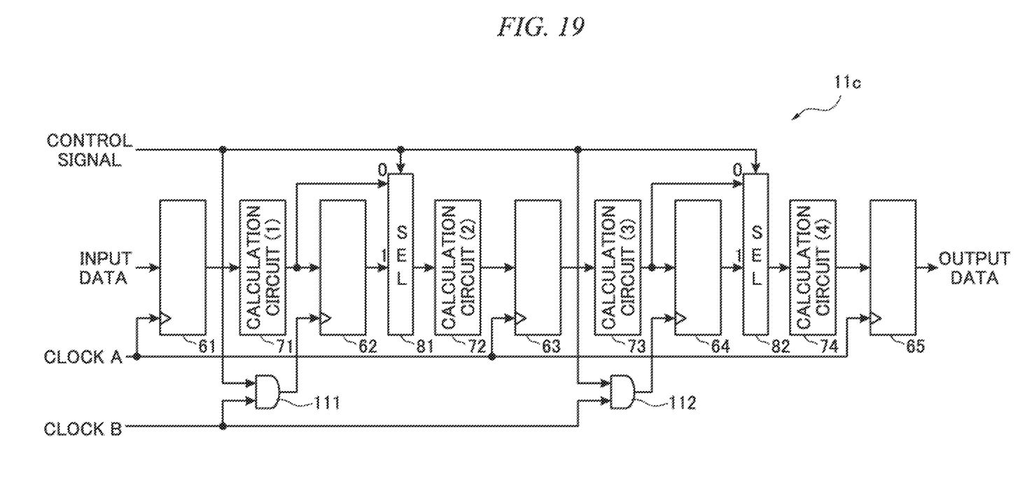

Next, a seventh embodiment of the present invention will be described with reference to the accompanying drawings. FIG. 19 shows a configuration example of a pipeline calculation processing unit 11c according to the present embodiment. The pipeline calculation processing unit 11c shown in FIG. 19 has a configuration in which a portion of the pipeline calculation processing unit 11 according to the first embodiment shown in FIG. 2 is modified. Note that input and output signals (data, clocks, and a control signal) of the pipeline calculation processing unit 11c shown in FIG. 19 are the same as the input and output signals of the pipeline calculation processing unit 11 shown in FIG. 2. The pipeline calculation processing unit 11c shown in FIG. 19 is different from the pipeline calculation processing unit 11 according to the first embodiment shown in FIG. 2 in that two AND circuits 111 and 112 of two inputs are newly provided. Here, the AND circuits 111 and 112 are respectively provided in, for example, input units (for example, immediately before clock input terminals) of pipeline registers in association with pipeline registers (2) 62 and (4) 64 for which the input of a clock is desired to be stopped.

A control signal is input to one input of the AND circuit 111, and a clock B is input to the other input. An output of the AND circuit 111 is input to the clock input terminal of the pipeline register (2) 62. The control signal is input to one input of the AND circuit 112, and the clock B is input to the other input. An output of the AND circuit 112 is input to the clock input terminal of the pipeline register (4) 64. In this configuration, the clock B is supplied to the clock input terminals of the pipeline register (2) 62 and the pipeline register (4) 64 in a case which the control signal is “1”, and the supply of the clock B is stopped in a case which the control signal is “0”.

Note that the clock A and the clock B are output from the clock supply unit 12 (FIG. 1) by a common wiring, and may be branched before being input to the AND circuit 111 and the AND circuit 112. Further, in the present embodiment, a configuration in which the clock supply unit 12 (FIG. 1), the AND circuit 111, and the AND circuit 112 are combined with each other corresponds to a clock supply unit of the present invention. That is, outputs of the AND circuit 111 and the AND circuit 112 correspond to an output of the clock supply unit of the present invention.

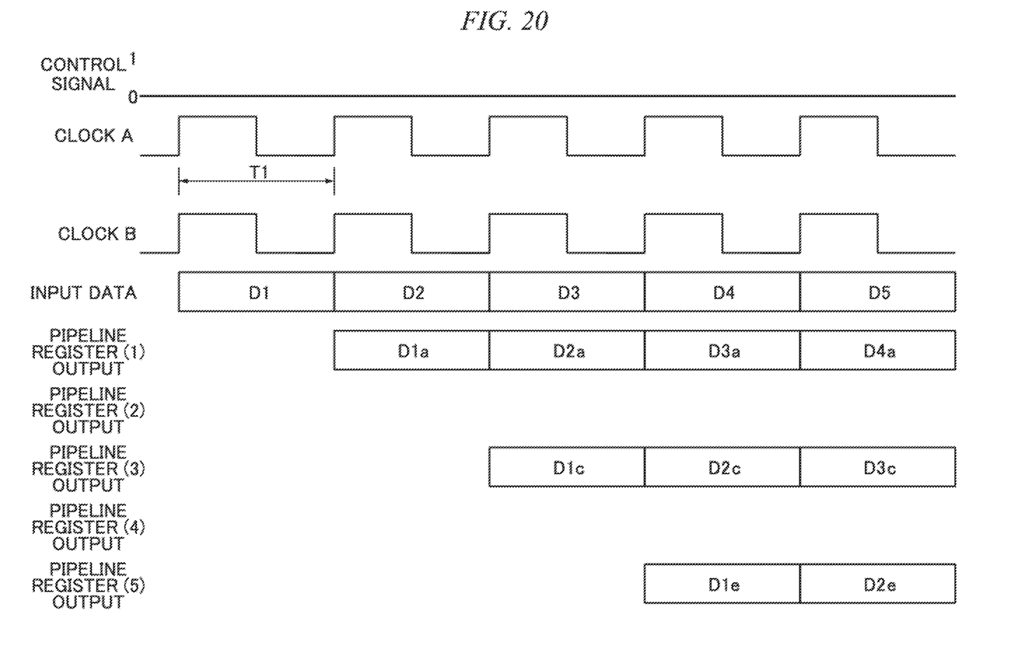

Next, an operation example of the pipeline calculation processing unit 11c shown in FIG. 19 will be described with reference to FIG. 20. FIG. 20 is a timing chart showing the operation of each unit in a case in which the pipeline calculation processing unit 11c shown in FIG. 19 is operated in a live-view imaging mode. The pipeline calculation processing unit 11c according to the present embodiment is operated in a movie imaging mode (high-speed mode) and a live-view imaging mode (low-speed mode), for example, similar to the pipeline calculation processing unit 11 according to the first embodiment. Here, operations of the pipeline calculation processing unit 11c according to the present embodiment in the movie imaging mode (high-speed mode) are the same as the operations of the pipeline calculation processing unit 11 according to the first embodiment described with reference to Table 1, FIG. 4, and the like, but some of the operations thereof in the live-view imaging mode (low-speed mode) are different from each other. Hereinafter, operations of the pipeline calculation processing unit 11c according to the present embodiment in the live-view imaging mode (low-speed mode) will be described.

<Live-View Imaging Mode (Low-Speed Mode)>

In the seventh embodiment, similar to the first embodiment, as shown in Table 2, the control signal is “0”, the clock A having a frequency of 250 MHz is supplied to pipeline registers (1) 61, (3) 63, and (5) 65 which are odd stages of the pipeline calculation processing unit 11, and the clock B is not supplied to the pipeline registers (2) 62 and (4) 64 which are even stages. However, unlike Table 2, the clock B can be set to be maintained in an “ON” state. That is, in the seventh embodiment, the clock B is supplied to one input of each of the AND circuit 111 and the AND circuit 112 and the control signal “0” is input to the other input of each of the AND circuit 111 and the AND circuit 112, so that outputs of the AND circuit 111 and the AND circuit 112 can be set to “0”.

The pipeline registers (1) 61 to (5) 65 change input and output data as shown in FIG. 20. FIG. 20 shows changes with time of a control signal, a clock A, a clock B, input data, and outputs of the pipeline registers (1) 61 to (5) 65. One cycle T1 of each of the clock A and the clock B is 4 ns (=1/(250 MHz)). Pieces of data D1a to D4a are pieces of data obtained by delaying pieces of input data D1 to D4 by one clock. Results obtained by sequentially performing calculation processing on the data D1a to D4a by a calculation circuit (1) 71 and a calculation circuit (2) 72 are pieces of data D1c to D4c (here, the data D4c is not shown in the drawing). Results obtained by sequentially performing calculation processing on the data D1c to D3c by a calculation circuit (3) 73 and a calculation circuit (4) 74 are pieces of data D1e to D3e (here, the data D3e is not shown in the drawing).

In the above-described first to sixth embodiments, the supply of the clock B and the like are stopped at the root of the clock supply unit. However, in the present embodiment, supply is stopped at the end of a clock signal by ANDing a clock to be input to a pipeline register for which supply is desired to be stopped and a control signal as shown in FIG. 19. For example, in the third embodiment, since a control signal is not connected to a pipeline register as shown in FIG. 12, control is performed only at the root of a clock in a case in which the supply of the clock is stopped at the time of a low-speed operation. On the other hand, in the seventh embodiment, a logical product of a control signal and a clock signal is connected to a pipeline register as a clock, and thus it is possible not only to perform control at the root of the clock in a case in which the supply of the clock is stopped but also to stop supply at the pipeline register which is the end of the clock.

As described above, according to the seventh embodiment, it is possible to perform a pipeline operation with an appropriate number of pipeline stages in accordance with a clock frequency to be supplied to the pipeline calculation processing unit 11c and to easily suppress power consumption due to an unnecessary pipeline register or the like. In addition, according to the seventh embodiment, a supply state and a supply stop state of the clock B can be switched by an AND circuit provided at a front stage of a clock input of each pipeline register, and thus it is easy to achieve a more simple configuration than, for example, a configuration in which the clock B is supplied or the supply of the clock B is stopped at the output stage of the clock supply unit 12 (FIG. 1). Note that the AND circuit may be provided in association with each pipeline register, or may be provided for a plurality of pipeline registers.

While the embodiments of the invention have been described in detail with reference to the accompanying drawings, a specific configuration is not limited to the embodiments, and designs and the like are also included within the scope without departing from the scope of the invention. For example, data to be processed by the image-processing unit 1, the pipeline calculation processing unit 11, and the like is not limited to image data. In addition, for example, although systems of clocks have been described as embodiments up to three systems of a high speed, a medium speed, and a low speed, the invention is not limited thereto, and systems of clocks may be four or more systems. In addition, regarding a control signal, the control signal may be changed not by the number of processing pixels but in units of frames or in units of small blocks obtained by dividing a frame into small blocks in accordance with an operation mode or a bus band. In addition, although the control signal can be determined by parameters within an image-processing unit, the invention is not limited thereto, and a control signal may be generated by performing discrimination at a frequency division ratio of a clock within a clock generation unit.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A calculation device, comprising:
a pipeline calculation processing unit having a plurality of calculation circuits, a plurality of pipeline registers and a plurality of data selection units which are connected through a pipeline, the pipeline calculation processing unit configured to perform a calculation with respect to input data and output a calculation result; and
a clock supply unit having at least two clock outputs, the clock supply unit configured to associate each clock output with one of the plurality of pipeline registers and supply one or more than one selected clock outputs to the associated pipeline registers among the plurality of pipeline registers,
wherein the clock supply unit is configured to switch states of each clock output according to an input control signal, and
wherein the plurality of data selection units are configured to select and output either of output of the pipeline register or output of the calculation circuit according to the control signal.

2. The calculation device according to claim 1, further comprises a control signal output unit configured to generate and output the control signal for controlling the plurality of data selection units and the clock outputs of the clock supply unit according to an input parameter,
wherein the clock supply unit is configured to stop supplying any clock output in accordance with the control signal.

3. The calculation device according to claim 2,
wherein the parameter includes first information corresponding to a processing amount of the calculation per unit time with respect to the input data, and
wherein the control signal output unit is configured to generate and output the control signal at least according to the first information.

4. The calculation device according to claim 1, wherein the plurality of pipeline registers are configured to stop operations according to the control signal.

5. An image-processing device, comprising:
a scene recognition unit configured to recognize a scene of input image data and output a recognition result as scene information;
a pipeline calculation processing unit having a plurality of calculation circuits, a plurality of pipeline registers and a plurality of data selection units which are connected through a pipeline, the pipeline calculation processing unit configured to perform a calculation with respect to the image data and output a calculation result;
a clock supply unit having at least two clock outputs, the clock supply unit configured to associate each clock output with one of the plurality of pipeline registers and supply one or more than one selected clock outputs to the associated pipeline registers among the plurality of pipeline registers; and
a control signal output unit configured to generate and output control signal for controlling the plurality of data selection units and clock outputs of the clock supply unit according to the scene information,
wherein the clock supply unit is configured to switch states of each clock output according to the control signal, and
wherein the plurality of data selection units are configured to select and output either of output of the pipeline register or output of the calculation circuit according to the control signal.

6. The image-processing device according to claim 5, wherein the clock supply unit is configured to stop supplying any clock output in accordance with the control signal.

7. The image-processing device according to claim 5, wherein the plurality of pipeline registers are configured to stop operations according to the control signal.

8. An image-processing method in an image-processing device having a plurality of calculation circuits, a plurality of pipeline registers, and a plurality of data selection units which are connected through a pipeline, comprising:
a step of recognizing a scene of input image data and outputting a recognition result as scene information;
a step of performing a calculation with respect to the image data and outputting a calculation result;
a step of outputting at least two clock outputs, associating each of at the clock output with one of the plurality of pipeline registers, and supplying one or more than one selected clock outputs to the associated pipeline registers among the plurality of pipeline registers; and
a step of generating and outputting control signal for controlling the plurality of data selection units and the clock outputs according to the scene information,
wherein states of each clock output are switched according to the control signal, and
wherein either of output of the pipeline register or output of the calculation circuit are selected and output according to the control signal.
